(19) United States
(12) Patent Application Publication
(10) Pub. No.: US 2016/0258548 A1
(43) Pub. Date: Sep. 8, 2016

(54) Device for Moving a Valve Closing Member, Valve Having Said Device, Corresponding Operating Method

(71) Applicant: FAURECIA SYSTEMES D'ECHAPPEMENT, Nanterre (FR)

(72) Inventors: Xavier Bartolo, Bois Le Roi (FR); Frederic Greber, Ecot (FR)

(21) Appl. No.: 15/055,763

(22) Filed: Feb. 29, 2016

(30) Foreign Application Priority Data
Mar. 6, 2015 (FR) 15 51907

(51) Int. Cl. F16K 31/44

(52) U.S. Cl. CPC F16K 31/44

(57) ABSTRACT

A driving device comprises a support, an actuator provided with an output shaft and fixed to the support, and an arm having a distal point provided to be connected to the closing member. A kinematic chain converts a rotation of the output shaft into a rotational movement of a proximal point of the arm around a rotation axis. The proximal and distal points are situated at opposite ends of the arm. The kinematic chain comprises a link connecting the arm to the support. The link is arranged to guide the proximal point of the arm in rotation around the rotation axis, and to transmit, between the arm and the support, radial orientation forces relative to the rotation axis.

### RELATED APPLICATION

This application claims priority to FR 15 51907, filed Mar. 6, 2015.

### TECHNICAL FIELD

The invention generally relates to the field of valve closing members. More specifically, the invention relates, according to a first aspect, to a device for driving a valve closing member, of the type comprising: a support; an actuator provided with a rotating output shaft, the actuator being fixed to the support; an arm having a distal point provided to be connected to the closing member; and a kinematic chain converting a rotation of the output shaft into a rotational movement of a proximal point of the arm around a rotation axis, the proximal and distal points being situated at opposite ends of the arm.

### BACKGROUND

One device, in particular, is known from U.S. 2009/139,502. This document describes a kinematic chain that includes a single lever, rigidly fixed on an output shaft of an actuator and connected to an arm by a ball joint. The arm in turn is connected by a ball joint to a second lever, which in turn is rigidly fixed to a pivot axis of a valve closing member.

It has been observed that driving devices of this type have a limited lifetime. In this context, the invention aims to propose a driving device having a longer lifetime.

### SUMMARY

A driving device as mentioned above, includes a kinematic chain that comprises a link connecting the arm to the support. The link is arranged to guide the rotation of the proximal point of the arm around the rotation axis and to transmit, between the arm and the support, radial orientation forces relative to the rotation axis.

The radial orientation forces relative to the rotation axis are therefore not transmitted from the arm to the output shaft of the actuator, and to the motor of the actuator.

These forces are directly reacted by the support. The constraints experienced in particular by the rotational guide bearings of the output shaft, or by the housing of the actuator, are considerably reduced. The lifetime of the actuator, and therefore of the driving device, is extended.

The device may also have one or more of the features below, considered individually or according to all technically possible combinations:

the rotation axis is aligned with the output shaft;

the kinematic chain comprises an intermediate pivot to which the proximal point of the arm is connected, the link of the arm to the support comprising a pivot link of the intermediate pivot to the support around the rotation axis;

the kinematic chain comprises a torsion spring rotatably linking the output shaft and the intermediate pivot;

the torsion spring is arranged to bias the intermediate pivot axially toward the support;

the device is provided to drive the closing member between first and second extreme positions, the arm in the first extreme position being oriented such that:

the proximal and distal points define a main direction,

the rotation axis and the proximal point define a second direction, and

the main direction and the second direction form an angle smaller than 45° between them;

the arm is elastic in a main direction passing through the proximal and distal points;

the device is provided to drive the closing member between first and second extreme positions, at least one of said positions being defined by a stop against which the arm bears when the closing member arrives in said position.

According to a second aspect, the invention relates to an assembly comprising a valve provided with a closing member, and a device for driving the closing member having the above features.

Furthermore, the valve includes a body defining a fluid passage pathway, the closing member being mounted in the passage pathway pivoting relative to the body around a pivot axis, the closing member being asymmetrical relative to the pivot axis such that the fluid exerts a pressure tending to pivot the closing member relative to the pivot axis in a determined rotation direction.

According to a third aspect, the invention pertains to a vehicle exhaust line, equipped with an assembly having the above features.

The valve is typically a valve known under the name EHRS (Exhaust Heat Recovery System). Such a valve is used to direct the exhaust gases either toward a heat exchanger in which the exhaust gases cede part of their heat energy to a heat transfer fluid, or toward a duct making it possible to bypass the heat exchanger.

According to a fourth aspect, the invention relates to an operating method for an assembly having the features above,

the kinematic chain comprising an intermediate pivot to which the proximal point of the arm is connected, and the torsion spring rotatably connecting the output shaft and the intermediate pivot, the method comprising the following steps:

moving the closing member to a first extreme position where the closing member is abutting, rotating the output shaft in a first direction; and

rotating the output shaft in the first direction by at least 3°, to charge the torsion spring and block the closing member in the first extreme position.

These and other features may be best understood from the following drawings and specification.

### BRIEF DESCRIPTION OF THE DRAWINGS

Other features and advantages of the invention will emerge from the following detailed description, provided for information and non-limitingly, in reference to the appended figures, in which:

FIG. 1 is an exploded view of a driving device according to a first embodiment of the invention, and an EHRS valve;

FIG. 2 is a top view of the assembly of FIG. 1, the closing member being in the bypass position;

FIG. 3 is a view similar to that of FIG. 2, the closing member being in the heat exchange position, the arm not yet being abutting;

FIG. 4 is a view similar to that of FIGS. 2 and 3, the closing member being in the heat exchange position and the arm being abutting;

FIG. 5 is an exploded view of the assembly according to a second embodiment of the invention; and

FIG. 6 is a top view of the assembly of FIG. 5, part of the elements not being shown in order to show the position of the arm precisely.

### DETAILED DESCRIPTION

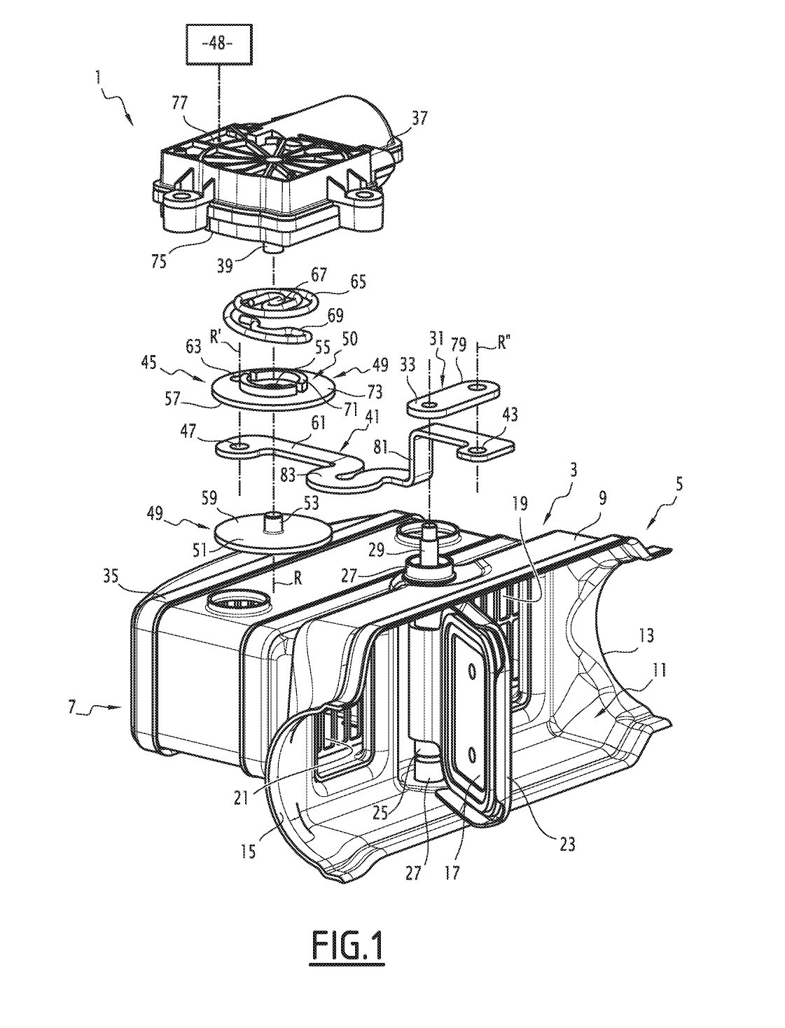

The driving device 1 shown in FIG. 1 is designed to drive a valve closing member. In the illustrated example, this valve is a valve known under the name EHRS, installed in the exhaust line of a vehicle. This vehicle is typically a motor vehicle, for example a car or truck.

Alternatively, the valve is installed in another piece of equipment of the exhaust line. The valve can also be installed in another circuit of the vehicle, for example a hydraulic circuit, a conditioned air circuit or any other circuit. It can also be used in places other than a vehicle.

As shown in FIG. 1, in the illustrated example, the valve 3 is part of a heat recovery device 5.

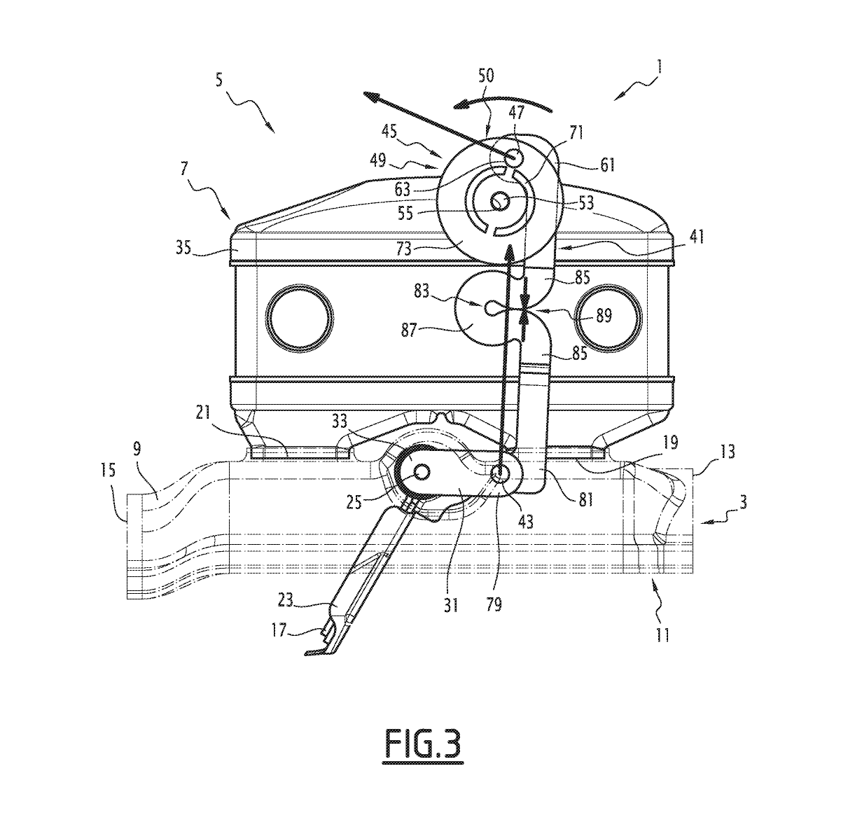

The heat recovery device includes a heat exchanger 7. The valve 5 includes a valve body 9, only half of which is shown in FIGS. 1 to 4, inwardly defining a direct passage pathway 11 for the exhaust gases, from an inlet 13 to an outlet 15.

As shown in FIG. 1, the valve includes a closing member 17, able to close off the central segment of the passage pathway 11.

The heat exchanger 7 includes an exhaust gas circulation passage, and a circulation passage for a heat transfer fluid, the heat transfer fluid being in thermal contact with the exhaust gases in the heat exchanger. These passages are not shown in the figures. The exhaust gas circulation passage emerges in the passage pathway 11 through an exhaust gas inlet 19 and an exhaust gas outlet 21, respectively situated upstream and downstream from the central segment. Upstream and downstream here refer to the circulation direction of the exhaust gases.

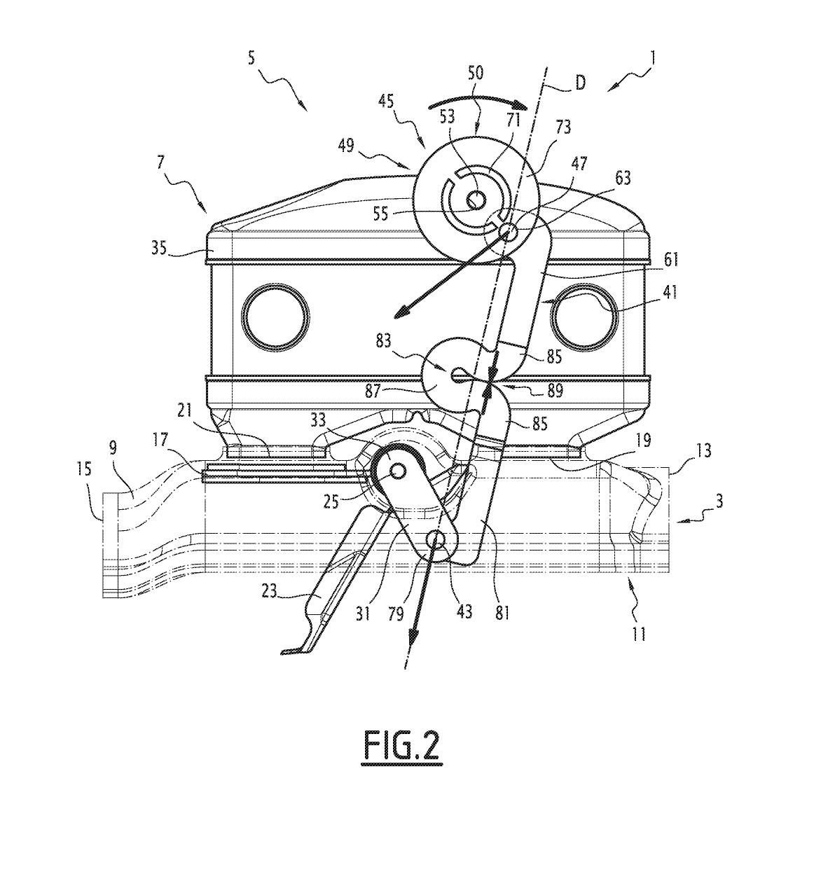

Thus, the driving device 1 is provided to move the closing member 17 between a first extreme position, shown in FIG. 1, in which the closing member 17 closes off the central segment of the passage pathway 11, and a second extreme position, shown in FIG. 2, in which the closing member closes off the circulation passage of the exhaust gases through the heat exchanger 7 and frees the passage pathway 11.

In the illustrated example, the valve includes a frame 23, secured to the enclosure 9, and positioned in the central segment. The closing member 17 bears against the frame 23 in its first extreme position, which is also called heat exchange position.

As shown in FIG. 2, in the second extreme position, the closing member 17 closes off the outlet 21. The closing member 17 then bears against a sealing step surrounding the outlet 21. The second extreme position is also called a bypass position.

Furthermore, as shown in FIG. 2, the valve 3 also includes a pivot shaft 25 mounted pivoting relative to the enclosure 9 in bearings 27, an end part of the pivot shaft 25 protruding outside the enclosure 9. The valve also includes a lever 31 secured by one end 33 to the end part of the shaft 25.

It should be noted that the closing member 17 is asymmetrical relative to the pivot shaft 25. Thus, the exhaust gases exert a pressure on the closing member tending to pivot the closing member 17 about an end part 29 of pivot shaft 25 in a determined rotation direction. In the illustrated example, the exhaust gases bias the closing member 17 in rotation toward its second extreme position.

In the example of FIGS. 1 and 2, the closing member 17 is completely situated on one side of the end part 29 of pivot shaft 25. In this respect, it differs from butterfly-type valves, in which the closing member is distributed symmetrically on either side of the pivot axis.

Alternatively, the closing member includes two parts, situated on either side of the pivot shaft 25, these parts not being the same size.

The driving device 1 includes a support 35, an actuator 37 provided with an output shaft 39, and with the actuator 37 being fixed to the support 35. The driving device 1 also includes an arm 41 having a distal point 43 provided to be connected to the closing member;, and a kinematic chain 45 converting a rotation of the output shaft 39 into a rotational movement of a proximal point 47 of the arm 41 around a rotation axis R.

In the illustrated example, the support 35 corresponds to the enclosure of the heat exchanger 7. Alternatively, it is another structure of the exhaust line of the motor vehicle. The actuator 37 is fixed to the support using any appropriate method or structure, for example by screws or weld spots.

The actuator 37 is typically an electric motor, preferably small. The actuator 37 is driven by a computer 48.

In the illustrated example, the output shaft 39 is substantially parallel to the pivot shaft 25 of the valve. Alternatively, it is inclined relative to the pivot shaft 25.

In order to simplify the kinematic chain as much as possible, the rotation axis R is parallel to and aligned with the output shaft 39. It is in the extension of the output shaft 39. Alternatively, the output shaft 39 and the axis R are offset relative to one another, while for example remaining parallel to one another.

The proximal and distal points 47, 43 of the arm 41 are situated at opposite ends of that arm 41.

Typically, the arm 41 is a planar, metal rod.

According to the invention, the kinematic chain 45 comprises a link 49 connecting the arm 41 to the support 35, and which is arranged to guide the proximal point 47 of the arm 41 in rotation around the rotation axis R, and to transmit, between the arm 41 and the support 35, radial orientation forces relative to the rotation axis R.

More specifically, the kinematic chain 45 comprises an intermediate pivot 50 to which the proximal point 47 of the arm 41 is connected, and the link 49 of the arm 41 to the support comprising a pivot link of the intermediate pivot 50 to the support 35 around the rotation axis R. The proximal point 47 is connected in rotation to the intermediate pivot 50 around the rotation axis R.

In the embodiment of FIG. 1, the link 49 includes a base 51, provided with a substantially cylindrical lug 53, which points from the base 51 along the rotation axis. The intermediate pivot 50 is mounted rotating freely around the lug 53, via a central orifice 55.

The base 51 is rigidly fixed to the support 35, through any appropriate method or structure, for example screws or welding.

As shown in FIG. 1, the intermediate pivot 50 is a thin plate, axially inserted between the base 51 and the actuator 37.

This plate of the intermediate pivot 50 extends in a plane substantially perpendicular to the rotation axis R.

The plate is defined toward the base 51 by a large planar face 57. The base 51 has, toward the intermediate pivot 50, a large planar face 59, substantially perpendicular to the rotation axis R. The lug 53 protrudes axially relative to the large planar face 59. The large planar faces 57 and 59 are parallel to one another, and superimposed on one another. The proximal end 61 of the arm 41 bearing the proximal point 47 also fits in a plane substantially perpendicular to the rotation axis R, and is positioned between the two large planar faces 57 and 59. This proximal end 61 travels in the plane perpendicular to the axis R, between the large planar faces 57 and 59.

In the illustrated example, the proximal point 47 is linked to the intermediate pivot 50 by a lug 63, protruding axially below the large planar face 57. The proximal point 47 includes an orifice, in which the lug 63 is engaged freely rotating. A pivot link around an axis R′ is thus established. The axis R′ is parallel to the axis R, and radially offset relative to the axis R.

The kinematic chain 45 also includes a torsion spring 65, rotatably linking the output shaft 39 and the intermediate pivot 50.

The output shaft 39 is linked to the intermediate pivot 50 only by the torsion spring 65.

In the illustrated example, the torsion spring 65 is a bent metal wire.

A first end 67 of the spring is clipped on the output shaft 39. The output shaft 39 to that end has a slot (not shown) designed to receive the first end 67 of the spring. The second end 69 of the spring is rotatably linked to the intermediate pivot 50 by ribs 71, arranged on the intermediate pivot 50. The ribs 71 are supported by a large base 73 of the intermediate pivot, opposite the large planar face 57.

It should be noted that the torsion spring 65 is arranged to bias the intermediate pivot 50 axially toward the support 35.

Thus, the torsion spring 65 contributes to keeping the intermediate pivot 50 linked to the support 35 by the pivot link. More specifically, it contributes to keeping the lug 53 engaged in the orifice 55.

Furthermore, the torsion spring 65 contributes to keeping the arm 41 between the large planar faces 57 and 59, and contributes to keeping the proximal point 47 of the arm linked to the intermediate pivot 50. To that end, the axial separation between the intermediate pivot 50 and a lower face 75 of the housing 77 of the actuator is, for example, adjusted to the appropriate value.

The distal point 43 of the arm 41 is linked to the lever 31, typically by a pivot link around an axis R″ parallel to the axis R′. The distal point 43 is linked to one end 79 of the lever 31, opposite the end 33.

In the embodiment of FIGS. 1 to 4, the arm 41 is elastic in a main direction D passing through the proximal 47 and distal 43 points. This direction D is, for example, shown in FIG. 2.

This means that when the arm 41 is subject to a traction force in the main direction D, which is greater than a predetermined pre-stressed value, the arm 41 will be elongated in the direction D. To that end, the arm 41 includes, aside from the proximal end part 61, a distal end part 81 and a a-shaped (omega shaped) central part 83. The proximal end part 61 has an orientation substantially parallel to the main direction D. As shown in FIG. 2, the distal end part 81 is also oriented generally parallel to the main direction D. The end parts 61 and 81 are in the extension of one another. It should be noted, as shown in FIG. 1, that the parts 61 and 81 can include recesses. The a-shaped central part 83 has two opposite ends 85, connected to the end parts 61 and 81. They also include a bowed central segment 87, extending practically over 360°, and connecting the ends 85 to one another. The ends 85 are in contact against one another when idle. Alternatively, the ends 85 are separated from one another, when idle, by a very narrow interstice 89 in the main direction D.

Thus, when the arm 41 is subject to a compression force, the ends 85 bear against one another such that the shortening of the arm 41 is substantially null. On the contrary, when the arm 41 is subject to a traction force, tending to separate the proximal point and the distal point from one another along the main direction, the ends 85 move away from one another. The interstice 89 becomes wider. This separation occurs if, as indicated above, the traction force is above the predetermined strain value, for example 100 N.

The operation of the driving device described above will now be outlined. The driving device, in particular the actuator 37, is driven by the computer 48. The computer 48 is programmed to carry out the method that will be described below.

To switch the closing member from the first extreme position to the second extreme position, the actuator rotates the output shaft 39 in a second rotation direction, which is the clockwise direction in the illustrated example (see FIG. 2). The rotational movement of the output shaft 39 is transmitted to the intermediate pivot 50 by the torsion spring 65.

The proximal point 47 of the arm 41 is in turn rotated around the rotation axis R. It is moved in a general direction bringing it towards the end part 29 of pivot shaft 25 of the closing member. This direction is substantially parallel to the main direction D.

Due to the movement of the proximal point, the arm 41 is subject to the compression force, in the main direction D. The two ends 85 of the a-shaped central part 83 are already in contact against one another, such that the force is transmitted without significant modification of the length of the arm 41.

The motor torque is transmitted via the output shaft 39, and the torsion spring 65 and the intermediate pivot 50 is transmitted by the arm 41 to the lever 31. The arm 41 behaves like a rigid beam.

The lever 31 is rotated around the end part 29 of pivot shaft 25, and rotates the closing member 17 to its second extreme position, which here is the bypass position. It should be noted that the torque required to move the closing member 17 to the bypass position is reduced due to the pressure exerted, in the illustrated example, by the exhaust gases on the closing member 17. The exhaust gases in fact bias the closing member 17 in rotation toward its bypass position.

The movement of the intermediate pivot 50 is blocked when the closing member 17 reaches its second position, due to the fact that the closing member 17 bears on the corresponding sealing step.

Advantageously, the actuator 37 next rotates the output shaft 39 in the second direction by at least 3°, preferably by an angle comprised between 5° and 30°, still more preferably an angle comprised between 10° and 20°, so as to charge the torsion spring 65 and block the closing member 17 in its second extreme position.

The actuator 37 is next stopped, with the output shaft 39 staying in position. The torsion spring 65 therefore continuously biases the closing member 17 toward the second extreme position.

This is particularly advantageous. Indeed, the vibrations and impacts experienced by the closing member will not cause unsticking of the closing member, which remains pressed against its sealing step under the effect of the return force from the torsion spring 65.

To switch the closing member 17 from the second extreme position to the first extreme position, the actuator 37 drives the output shaft 39 in a first rotation direction relative to the support. This direction of rotation is, in the example shown in the figures, the counterclockwise direction.

This rotational movement is transmitted by the torsion spring 65 to the intermediate pivot 50. The proximal point 47 is rotated around the rotation axis R, in a general direction separating this proximal point from the end part 29 of pivot shaft 25 of the closing member. This movement is done in a general direction substantially parallel to the main direction

D.

The lever 31 is driven by the arm 41, also in a counterclockwise direction around the end part 29 of pivot shaft 25. The lever 31 rotates the closing member 17 around the end part 29 of pivot shaft 25. The closing member 17 then reaches its first extreme position, and abuts against the frame 23.

The torque required to rotate the closing member 17 in the first direction will be higher than in the second case, since the exhaust gases bias the closing member toward the second extreme position.

The intermediate pivot 50 is not blocked in rotation when the closing member 17 reaches its first extreme position, due to the elasticity of the arm 41. On the contrary, the actuator 37 continues to rotate the intermediate pivot 50 around the rotation axis R, which gradually increases the traction force applied to the arm 41. When this traction force exceeds the predetermined pre-stress value, the arm 41 becomes elongated parallel to the main direction D. This is obtained by the fact that the two ends 85 of the a-shaped central part 83 of the arm move away from one another, such that an interstice 89 is created between the ends 85.

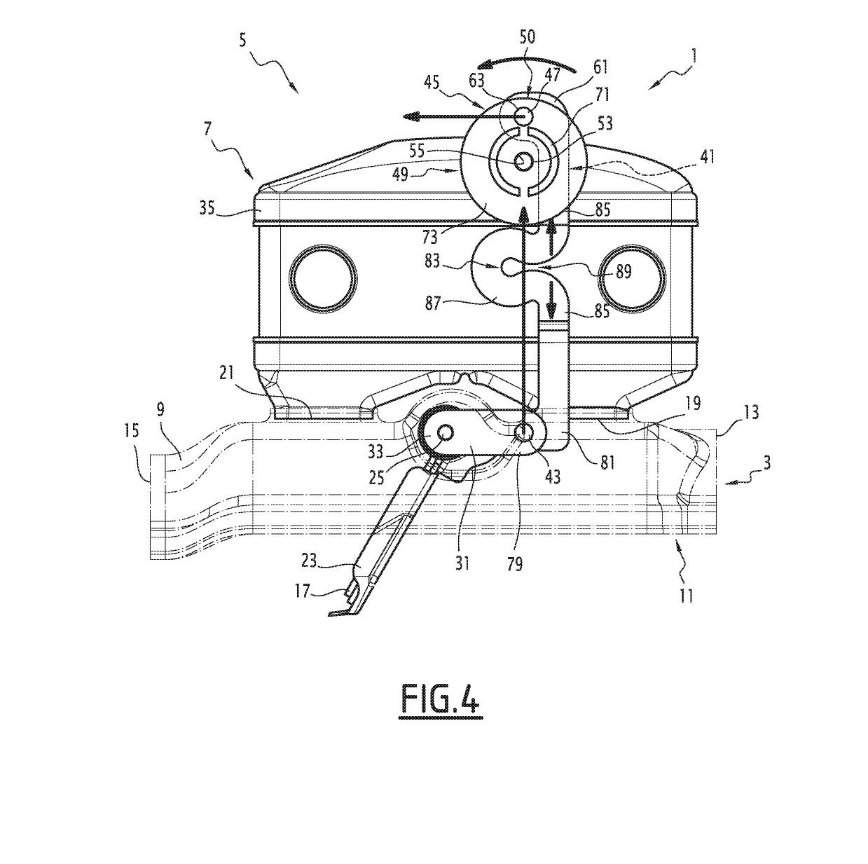

The rotational movement of the intermediate pivot 50 is blocked when the arm 41 abuts against the lug 53 (see FIG. 4).

As before, the actuator 37 then continues to rotate the output shaft 39 in the counterclockwise direction, so as to charge the torsion spring 65, and block the closing member 17 in its first extreme position. The actuator, after the abutment of the arm 41 against the lug 53, rotates the output shaft 39 over at least 3°, preferably over an angle comprised between 5° and 30°, still more preferably over an angle comprised between 10° and 20°.

The closing member 17 is thus greatly biased in rotation toward its first extreme position, i.e., against the frame 23. This makes it possible to keep the closing member 17 in its first extreme position, despite the impacts and vibrations transmitted to the closing member 17.

The stop stopping the movement of the arm 41 may not be the lug 53. This stop can be carried by the support 35, by the intermediate pivot 50, or by any other structure.

According to one important aspect of the invention, the arm 41 in the first extreme position is oriented such that the rotation axis R and the proximal point 47 define a second direction D′, and the main direction D and the second direction D′ form an angle a between them smaller than 45°.

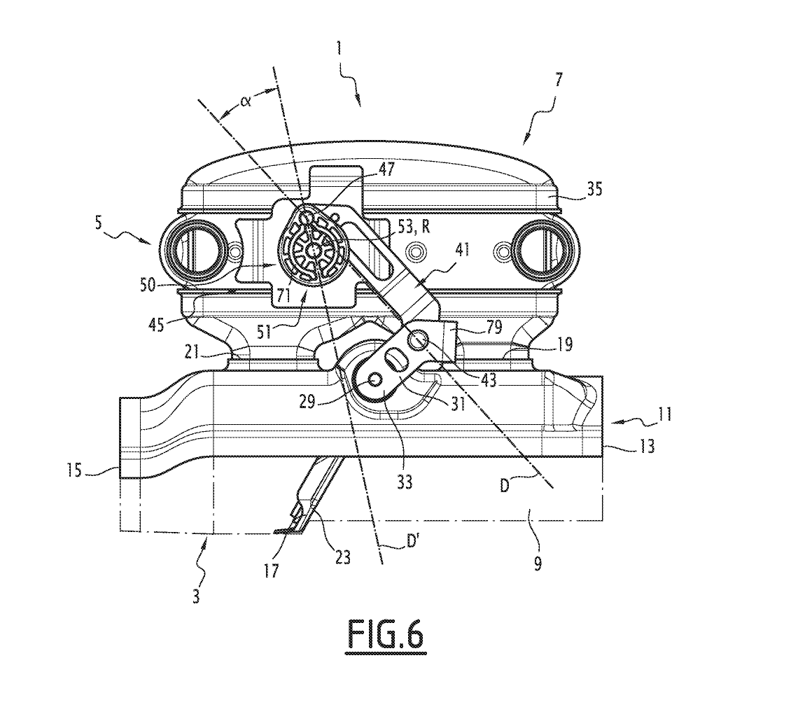

This situation is shown in FIG. 6. The angle a between the main direction D and the second direction D′ is embodied in this figure.

The arm 41 then occupies a position that can be qualified as “lower dead center”, by analogy with the operation of a connecting rod assembly.

As a result of this arrangement, a small rotational force transmitted by the actuator 37 to the intermediate pivot 50 produces significant rotational travel of the intermediate pivot in the vicinity of the lower dead center, significant traction consequently being applied to the arm 41. This makes it possible, with an actuator designed to produce a limited output torque at the output shaft 39, to obtain a much higher torque at the closing member 17, near its first extreme position.

For example, with an output torque of 0.7 newton meters, it is possible to obtain a torque of 3.5 newton meters at the closing member 17 in the vicinity of the first extreme position.

Of course, this torque depends on the separation between the end part 29 of pivot shaft 25 and the distal linking point 43, and the separation between the rotation axis R and the proximal linking point 47. However, the choice of a reduced angle a in the first extreme position of the closing member makes it possible to obtain, at the closing member, a much higher torque than a driving device of the type described in U.S. 2009/0,139,502, having the same separations.

It should be noted that the fact that the arm 41 is elastic makes it possible to increase the torque applied to the closing member when the latter is in its first extreme position.

Indeed, the angle a must be reduced, but must remain above the minimum value. This minimum value corresponds to the maximum traction force that the arm 41 and the pivot shaft 25 can withstand without being damaged. It is therefore necessary for the driving device to be designed such that the intermediate pivot is blocked, in light of the assembly allowances, in a position where the angle a is greater than the minimum guaranteeing the integrity of the device.

When the arm 41 is rigid, it is necessary to account for a relatively high safety margin for the position in which the intermediate pivot is blocked, so as to account for the assembly allowances. On the contrary, when the arm is flexible, the safety margin for the final position of the intermediate pivot can be reduced, since the arm will be elongated if the traction force applied to it is above the predetermined pre-stress value. The allowances become less critical. It is thus possible to provide that the intermediate pivot is blocked for a smaller angle a than with a rigid arm. The torque transmitted to the closing member 17 in its first extreme position can thus be higher. The arm 41 acts as a fuse.

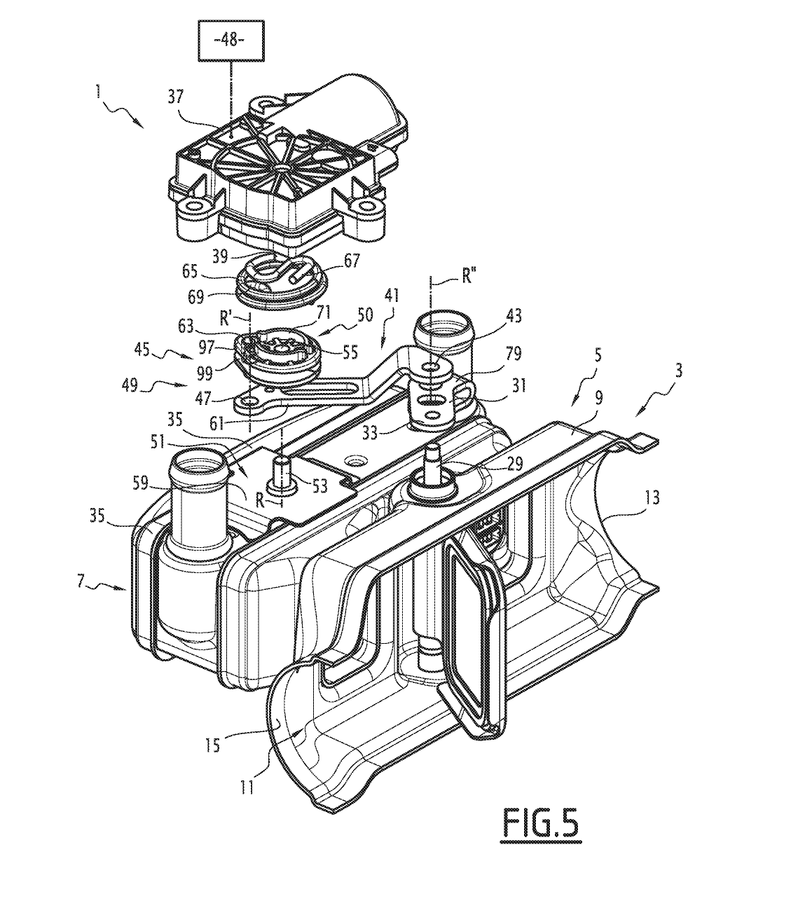

Thus, for a rigid arm 41, of the type illustrated in these FIGS. 5 and 6, the angle is preferably less than or equal to 30°. For an elastic arm 41, the angle a is preferably smaller than 15°, still more preferably smaller than 10°.

The arm 41 is pre-stressed at a value corresponding to the desired nominal torque for the closing member 17 in its heat exchange position, but lower than the traction causing the destruction of the driving device.

Obtaining a significant gear reduction between the torque generated by the actuator at the output shaft and the torque obtained at the closing member 17 makes it possible to use an actuator with a lower power, therefore a reduced bulk.

It should be noted that all of the component parts of the driving device have a small bulk.

The driving device can be easily adapted based on the size of the closing member and the size of the heat exchanger. In particular, the torque can be adjusted by acting on the geometry of the different elements making up the driving device, for example the arm 41, the lever 31 or the intermediate pivot 50.

The kinematic chain is adaptable to different types of actuator, since it only requires an adapted connection between the torsion spring 65 and the output shaft 39 of the actuator.

The radial orientation forces with respect to the rotation axis R are not transmitted from the arm 41 to the inner elements of the actuator, for example to the output shaft or the guide bearing of that output shaft. These forces, for example, come from vibrations transmitted by the vehicle, or the pulsed circulation of the exhaust gases. The radial forces applied to the intermediate pivot 50 are directly reacted by the base 51 and the support 35.

The housing of the actuator, which is generally made from plastic, is also protected from radial forces.

Furthermore, the torsion spring 65 provides an additional level of uncoupling of the output shaft 39 with respect to radial forces.

The torsion spring furthermore makes it possible to elastically bias the closing member toward its first extreme position or its second extreme position, permanently. Thus, the vibrations applied to the closing member do not lead to separating the closing member from its sealing step due to the return force from the torsion spring.

The torsion spring also protects the actuator from impacts resulting from the arrival of the closing member abutting in its first and second extreme positions.

One alternative embodiment of the invention will now be described in reference to FIG. 5. Only the differences between this alternative and that of FIGS. 1 to 4 will be outlined below. Identical elements or elements performing the same function will be designated using the same references in both embodiments.

In the alternative embodiment of FIG. 5, the arm 41 is rigid. This means that it does not include the a-shaped central segment 83.

Thus, in the first extreme position of the closing member, the intermediate pivot 50 stops its rotation when the closing member abuts against the frame.

The intermediate pivot 50 therefore no longer stops when the arm 41 abuts against a member provided to that end, for example against the lug 53.

Furthermore, the shape of the base 51 is different from the shape illustrated in FIGS. 1 to 4.

The intermediate pivot 50 includes two discs 97 and 99 superimposed on one another. The discs 97 and 99 are secured in rotation around the rotation axis R with one another. They define an annular slot between them in which the proximal end 61 of the arm 41 moves. The disc 97 bears the reliefs 71 making it possible to secure the torsion spring 65 and the intermediate pivot 50 in rotation. The disc 99 rests on the base.

It should be noted that the driving device could include a traditional lever in place of the intermediate pivot. This traditional lever could be arranged so that the angle a does not have a small value in the first extreme position of the closing member.

According to another alternative embodiment, the output shaft 39 could be connected directly to the intermediate pivot, without interposition of a torsion spring.

According to another, independent aspect, the invention relates to a device for driving a valve closing member, wherein the device includes: an actuator provided with a rotating output shaft, an arm having a distal point provided to be connected to the closing member, and a kinematic chain converting a rotation of the output shaft into a rotational movement of the proximal point of the arm around a rotation axis, with the proximal and distal points being situated at opposite ends of the arms. The kinetic chain comprises an intermediate pivot connected in rotation to the output shaft and rotatable around the rotation axis. The proximal point of the arm is linked to the intermediate pivot in rotation around the rotation axis. The device is provided to drive the closing member between first and second extreme positions, with the arm in the first extreme position being oriented such that the proximal and distal connecting points define a main direction, the rotation axis and the proximal point define a second direction, and the main direction and the second direction form an angle smaller than 45° between them.

Although an embodiment of this invention has been disclosed, a worker of ordinary skill in this art would recognize that certain modifications would come within the scope of this disclosure. For that reason, the following claims should be studied to determine the true scope and content of this disclosure.

1. A device for driving a valve closing member, the device comprising:
a support;
an actuator provided with an output shaft, the actuator being fixed to the support;
an arm having a distal point provided to be connected to the valve closing member;
a kinematic chain converting a rotation of the output shaft into a rotational movement of a proximal point of the arm around a rotation axis, the proximal and distal points being situated at opposite ends of the arm; and
wherein the kinematic chain comprises a link connecting the arm to the support, the link arranged to guide the rotation of the proximal point of the arm relative to the support around the rotation axis and to transmit, between the arm and the support, radial orientation forces relative to the rotation axis without passing through the output shaft.

2. The device according to claim 1, wherein the rotation axis is aligned with the output shaft.

3. The device according to claim 1, wherein the kinematic chain comprises an intermediate pivot to which the proximal point of the arm is connected, the link of the arm to the support comprising a pivot link of the intermediate pivot to the support around the rotation axis.

4. The device according to claim 3, wherein the kinematic chain comprises a torsion spring rotatably linking the output shaft and the intermediate pivot.

5. The device according to claim 4, wherein the torsion spring is arranged to bias the intermediate pivot axially toward the support.

6. The device according to claim 1, wherein the device is provided to drive the valve closing member between first and second extreme positions, the arm in the first extreme position being oriented such that:
the proximal and distal points define a main direction;
the rotation axis and the proximal point define a second direction; and
the main direction and the second direction form an angle between them that is smaller than 45°.

7. The device according to the claim 1, wherein the arm is elastic in a main direction passing through the proximal and distal points.

8. The device according to the claim 1, wherein the device is provided to drive the valve closing member between first and second extreme positions, at least one of the first and second extreme positions being defined by a stop against which the arm bears when the valve closing member arrives in the at least one of the first and second extreme position.

9. An assembly comprising:
a valve provided with a closing member; and
a device to drive the closing member, the device comprising a support, an actuator provided with an output shaft, the actuator being fixed to the support, an arm having a distal point provided to be connected to the closing member, a kinematic chain converting a rotation of the output shaft into a rotational movement of a proximal point of the arm around a rotation axis, the proximal and distal points being situated at opposite ends of the arm, and wherein the kinematic chain comprises a link connecting the arm to the support, the link arranged to guide the rotation of the proximal point of the arm relative to the support around the rotation axis and to transmit, between the arm and the support, radial orientation forces relative to the rotation axis without passing through the output shaft.

10. The assembly according to claim 9, wherein the valve includes a body defining a fluid passage pathway, the closing member being mounted in the passage pathway pivoting relative to the body around a pivot axis, the closing member being asymmetrical relative to the pivot axis such that the fluid exerts a pressure tending to pivot the closing member relative to the pivot axis in a determined rotation direction.

11. An operating method of an assembly comprising a valve provided with a closing member, a device to drive the closing member, the device comprising a support, an actuator provided with an output shaft, the actuator being fixed to the support, an arm having a distal point provided to be connected to the closing member, a kinematic chain converting a rotation of the output shaft into a rotational movement of a proximal point of the arm around a rotation axis, the proximal and distal points being situated at opposite ends of the arm, and wherein the kinematic chain comprises a link connecting the arm to the support, the link arranged to guide the rotation of the proximal point of the arm relative to the support around the rotation axis and to transmit, between the arm and the support, radial orientation forces relative to the rotation axis without passing through the output shaft, the kinematic chain comprising an intermediate pivot to which the proximal point of the arm is connected, and a torsion spring rotatably connecting the output shaft and the intermediate pivot, the method comprising the following steps:
moving the closing member to a first extreme position where the closing member is abutting, rotating the output shaft in a first direction; and
rotating the output shaft in the first direction by at least 3° to charge the torsion spring and block the closing member in the first extreme position.
